(19) United States
(12) Patent Application Publication
(10) Pub. No.: US 2009/0090308 A1
(43) Pub. Date: Apr. 9, 2009

(54) Accessory for animal collars

(76) Inventor: Courtney Bridges Nicholson, Alexandria, VA (US)

Correspondence Address: VENABLE LLP, P.O. BOX 34385, WASHINGTON, DC, 20043-9998, US

(21) Appl. No.: 12/078,421

(22) Filed: Mar. 31, 2008

Related U.S. Application Data
(60) Provisional application No. 60/907,371, filed on Mar. 29, 2007.

(51) Int. Cl. A01K 27/00

(52) U.S. Cl. 119/858

(57) ABSTRACT

An ornamental accessory includes a retainer member adapted to fit at least partially around a length of material, the retainer member including a first connector element, and an ornament including a second connector element adapted to removably connect with the first connector element. A method of attaching an ornamental accessory to a length of material is also disclosed.

### CROSS-REFERENCE TO RELATED APPLICATIONS

This application claims priority to U.S. Provisional Application No. 60/907,371, filed Mar. 29, 2007, the entire content of which is incorporated herein by reference.

### TECHNICAL FIELD

The present invention relates generally to animal collars, and more specifically, to animal collars having ornaments or other indicia that can be quickly and easily interchanged.

### BACKGROUND

Animal collars are known in the art, and can be worn, for example, by various types of animals such as pets, livestock, and wild animals. Animal collars can include tags or other indicia. For example, a dog collar can include dog tags identifying the dog and its owner. Alternatively, tags can be used to identify and track wild animals or livestock. Animal collars can alternatively include decorative ornaments or other accessories. However, known animal collars lack ornaments or other indicia that can be quickly and easily removed and replaced with new or different ornaments or indicia.

### SUMMARY OF THE INVENTION

According to an exemplary embodiment, an ornamental accessory comprises a retainer member adapted to fit at least partially around a length of material, the retainer member including a first connector element, and an ornament including a second connector element adapted to removably connect with the first connector element.

According to another exemplary embodiment, a method of attaching an ornamental accessory to a length of material comprises placing a retainer member at least partially around a portion of the length of material, and connecting a first connector element located on the retainer member with a second connector element located on the ornament.

### BRIEF DESCRIPTION OF THE DRAWINGS

FIG. 1 is a perspective view of an exemplary embodiment of an accessory according to the present invention, shown attached to an animal collar;

FIG. 2 is a back view of the accessory of FIG. 1, shown attached to an animal collar;

FIG. 3A is a side view of an exemplary retainer member of the accessory of FIG. 1;

FIG. 3B is a top view of the retainer member of FIG. 3A;

FIG. 4 is a perspective view of a second exemplary embodiment of an accessory according to the present invention;

FIG. 5 is a perspective view of a third exemplary embodiment of an accessory according to the present invention, shown attached to an animal collar;

FIG. 6 is a perspective view of an exemplary ornament of the accessory of FIG. 5;

FIG. 7 is a perspective view of the accessory of FIG. 5;

FIG. 8 is a side view of the accessory of FIG. 5, shown with the ornament detached from the retainer member; and

FIG. 9 is a bottom view of the accessory of FIG. 5.

### DETAILED DESCRIPTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without departing from the spirit and scope of the invention.

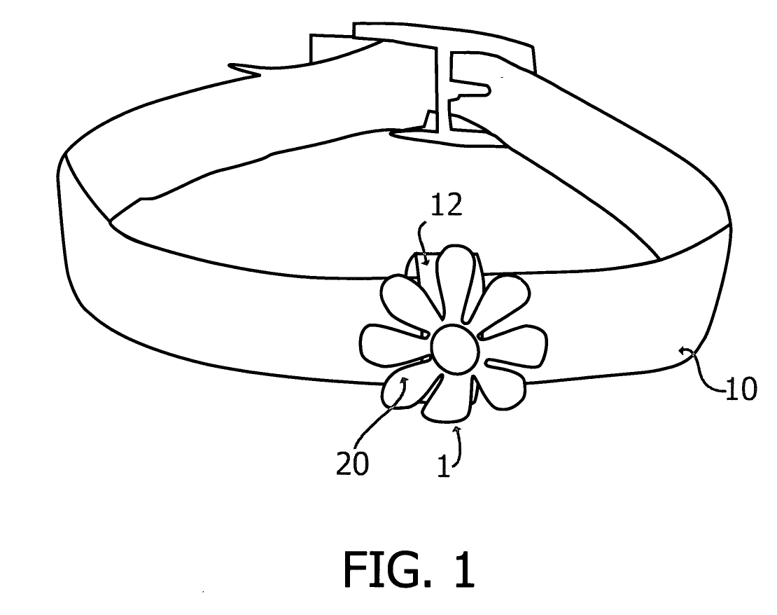

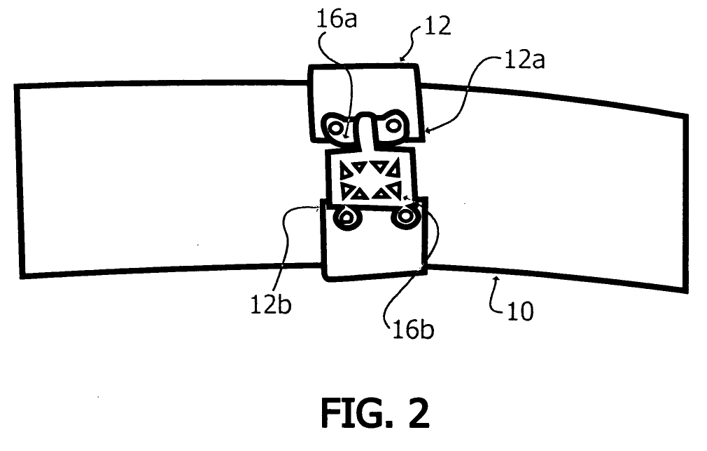

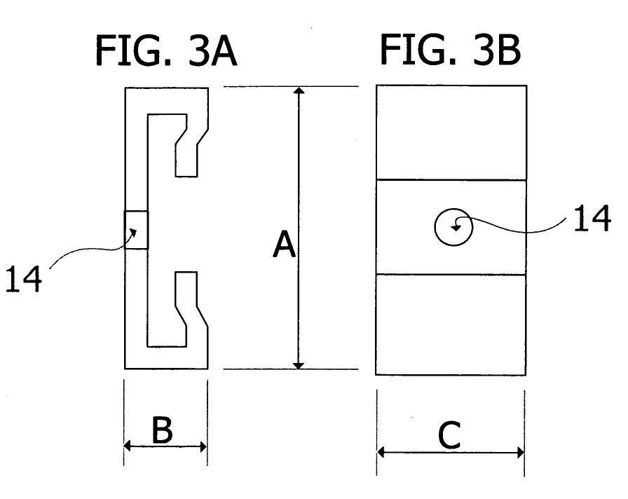

Referring to FIGS. 1 and 2, an exemplary accessory 1 for an animal collar 10 is shown. The accessory 1 can generally comprise a retainer member 12 adapted to fit at least partially around a portion of the animal collar 10. The retainer member 12 can have opposed first and second longitudinal ends 12a, 12b separated by an opening, as shown in FIG. 2. The opening can be dimensioned to allow the portion of the animal collar 10 to pass therethrough, for example, by bending or folding the portion of the animal collar 10. The retainer member 12 can include a first connector element 14 (illustrated in FIGS. 3A and 3B). The accessory can also include a clasp 16 adapted to close off the opening in the retainer member 12. The clasp 16 can include a first portion 16a attached to the first longitudinal end 12a of the retainer member 12, and a second portion 16b attached to the second longitudinal end 12b of the retainer member 12. An ornament 20 including a second connector element (hidden from view) can be adapted to removably connect with the first connector element 14. For example, the second connector element can comprise a projection, such as a pin or shaft, and the first connector element 14 can comprise an aperture or other receptacle adapted to receive the projection. The aperture can have a lock piece inside that engages the projection to secure the ornament. Alternatively, the first connector element 14 and the second connector element can comprise cooperating pieces of hook-and-loop material, such as Velcro®, attached to the first and second longitudinal ends, respectively. Alternatively, the first connector element 14 and the second connector element can be snaps that snap together. Alternatively, the first connector element 14 and the second connector element comprise magnetic elements attached to the first and second longitudinal ends, respectively.

The rear side of the ornament 20 (hidden from view in the figures) can be flat and can lay flush against the retainer member 12, however other configurations are possible.

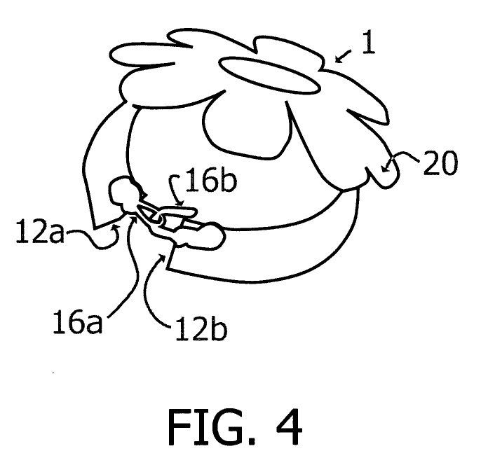

The retainer member 12 can be formed of leather (as shown in FIG. 4), plastic, such as molded plastic (as shown in FIGS. 1 and 2), or other known materials. The retainer member can be rigid, or alternatively, can be flexible. According to an exemplary embodiment, as shown in FIG. 4, the first portion 16a of the clasp can comprises a ring, and the second portion 16b of the clasp can comprise a hook adapted to catch on the ring. Alternatively, as shown in FIGS. 1 and 2, the clasp 16 can comprise a box-clasp. Alternatively, the first portion of the clasp 16a and the second portion 16b of the clasp can comprise magnetic elements. Alternatively, the first portion 16a of the clasp and the second portion 16b of the clasp can comprise cooperating pieces of hook-and-loop material, such as Velcro®.

The accessory 1 can comprise a plurality of different ornamental accessories. For example, the accessory can comprise at least one additional ornament that can be connected to the retainer in place of the first ornament. For example, the ornaments can be different sizes, shapes, colors, or have different themes for different seasons (e.g., Santa Claus for Christmas, Jack O Lanterns for Halloween, etc.) The ornaments can be formed of any material, such as plastic, metal, gold, silver, etc., and may contain jewels. Alternatively, the ornaments can include information about the animal wearing the collar 10, such as the animal's name, the animal's owner's name, or tracking information or other data for wild animals or livestock.

FIGS. 3A and 3B depict exemplary side and top views of the retainer member 12, and include dimension lines representing the length A, depth B, and width C of the retainer member 12. According to an exemplary embodiment, the retainer member 12 can have a length A of about 1.4 inches, a depth B of about 0.3 inches, and a width C of about 0.625 inches. Such an embodiment may be suitable, for example, for use with an animal collar 10 having a width of approximately 1.25 inches. According to another exemplary embodiment, the retainer member 12 can have a length A of about 1 inches, a depth B of about 0.25 inches, and a width C of about 0.5 inches. Such an embodiment may be suitable, for example, for use with an animal collar 10 having a width of approximately 0.875 inches. According to yet another exemplary embodiment, the retainer member 12 can have a length A of about 0.625 inches, a depth B of about 0.2 inches, and a width C of about 0.375 inches. Such an embodiment may be suitable, for example, for use with an animal collar having a width of approximately 0.5 inches. One of ordinary skill in the art will appreciate that other dimensions besides those listed are possible, for example, depending on the type and/or size of the animal collar 10, and/or, on the type of animal wearing the collar 10.

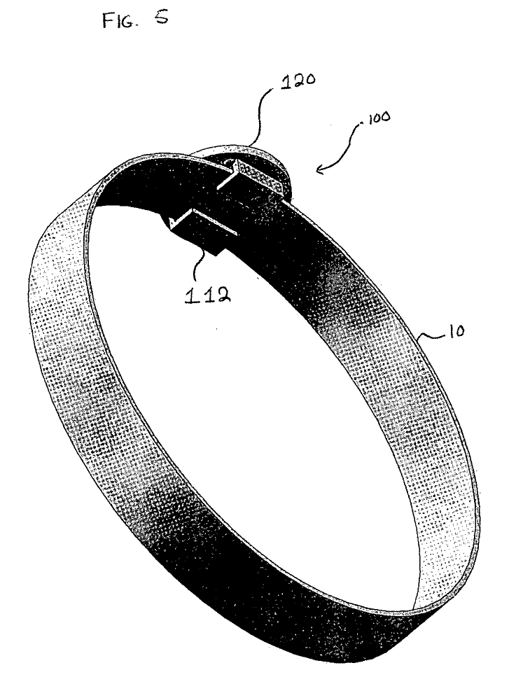

Referring to FIGS. 5-9, another exemplary embodiment of accessory 101 for an animal collar 10 is shown. The accessory 101 of FIGS. 5-9 is in many ways similar to the accessory 1 of FIGS. 1-4, and accordingly, only significant differences will be described in detail.

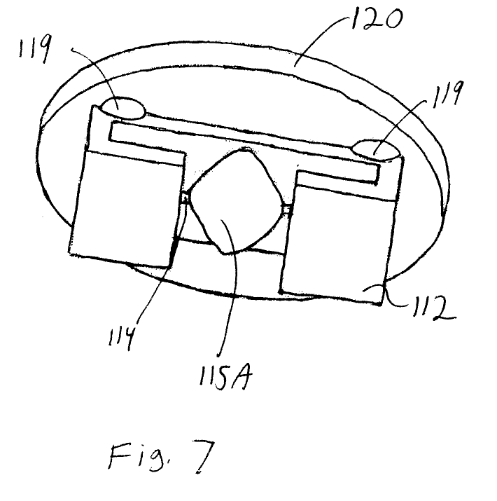

Referring to the exemplary embodiment shown in FIGS. 5-9, the ornament 120 can be attached and removed from the retainer member 112 using a rotational locking movement. For example, as best shown in FIGS. 7-9, the retainer member 112 can include a first connector element in the form of an aperture 114, and the ornament 120 can include a second connector element in the form of a projection 115.

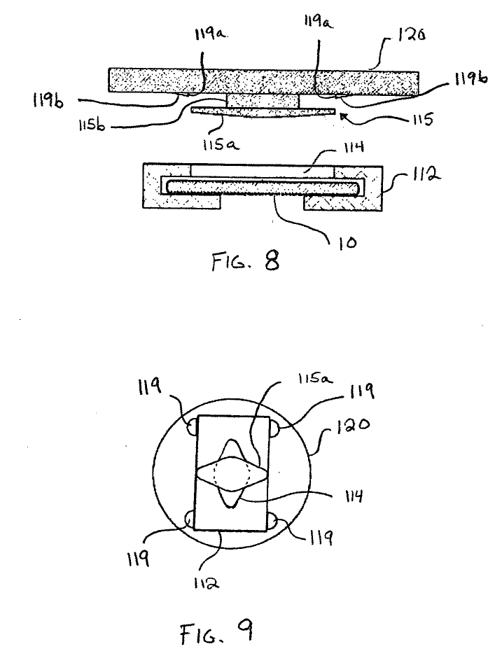

The projection 115 can include a locking portion 115a and a stem portion 115b that connects the locking portion 115a to the ornament 120, as shown in FIG. 8. The locking portion 115a can be sized and dimensioned to pass through the aperture 114 when the ornament 120 is located in a first, preselected angular orientation with respect to the retainer member 112, for example, the orientation shown in FIG. 8. More specifically, the outer circumference of the locking portion 115a can have a shape that permits its passage through the aperture 114 when the ornament 120 is in the first angular orientation with respect to the retainer member 112. In the exemplary embodiment shown, the locking portion 115a and the aperture 114 both have elongated diamond shapes, however, other shapes are possible. In addition, although aperture 114 and locking portion 115a have similar shapes in the exemplary embodiment shown, it is also possible that locking portion 115a and aperture 114 can have dissimilar shapes, provided that the shapes allow the locking portion 115a to pass through the aperture 114 when the ornament 120 is in the first angular orientation with respect to the retainer member 112.

As shown in FIGS. 7 and 9, the locking portion 115a and the aperture 114 can be dimensioned to prevent passage of the locking portion 115a through the aperture 114 when the ornament 120 is located in a second angular orientation with respect to the retainer member 112, for example, located approximately 90 degrees from the first angular orientation. As shown in FIGS. 7 and 9, when in the second angular orientation, a portion of the locking portion 115a can extend beyond the outer circumference of the aperture 114, thereby retaining the ornament 120 on the retainer 112.

The accessory 101 can further include one or more blocking members 119 that are adapted to inhibit rotation of the ornament 120 from the second angular orientation to the first angular orientation, for example, to prevent accidental removal and/or loss of the ornament 120. For example, as shown in FIG. 7, blocking members 119 can be located on the ornament 120, and can engage a portion of the retainer member 112 when the ornament 120 is located in the second angular orientation with respect to the retainer member 112. For example, as shown in FIG. 8, each blocking member 119 can comprise an inclined ramp surface 119b that permits the retaining member 112 to slide up and over the respective blocking member 119 toward the second angular orientation. As also shown in FIG. 8, each blocking member 119 can also include a substantially vertical surface 119a directed towards the retainer member 112 when the ornament 120 is in the second angular orientation with respect to the retainer member 112. The substantially vertical surfaces 119a engage corresponding substantially vertical surfaces on the retainer member 112 to prevent the ornament 120 from accidentally rotating toward the first angular orientation with respect to the retainer member 112. Therefore, the risk of accidental removal and/or loss of the ornament 120 can be reduced. When the user desires to remove the ornament 120, he or she can deform the ornament 120 and/or blocking members 119 and/or retainer member 112 sufficiently to obtain the necessary clearance to rotate the ornament 120 to the first angular orientation, thereby permitting removal of the ornament 120. According to an exemplary embodiment, the retainer member 112 and/or ornament 120 can be constructed from plastic, such as molded plastic. Additionally or alternatively, a clasp can be provided to close the opening in the retainer member 112, to prevent the accessory from falling off the collar 1, as previously described above in connection with FIGS. 1-4.

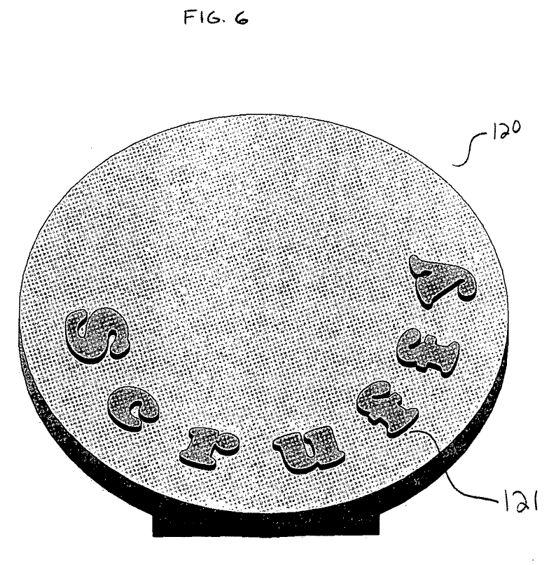

As shown in FIGS. 1 and 4, and described above, the ornaments 20, 120 can include decorative elements. As shown in FIG. 6, the ornaments 20, 120 can additionally or alternatively include information 121 about the animal wearing the collar. For example, the information 121 may include the animal's name. Alternatively, the information 121 may include the name and/or address of the animal's owner. Alternatively, the information 121 may include data used for scientific, feeding, or research purposes, for example, in connection with wild animals or livestock.

Methods of using the accessories 1, 101 will now be described in more detail. A method of attaching the accessory 1, 101 to an animal collar 10 comprises placing the retainer member 12, 112 at least partially around a portion of the animal collar. For example, in the instance of a rigid or substantially rigid retainer member 12, 112, this can comprise folding the collar 10 in half laterally and guiding it through the opening between the opposed first and second longitudinal ends of the retainer 12, 112. The longitudinal ends 12a, 12b can then be secured together, for example, using a clasp 16, if provided.

The ornament 20, 120 can then be attached to the retainer member 12, 112, for example, using the respective first connector element 14, 114 and the respective second connector element 115. For example, in the exemplary embodiments of FIGS. 1-4, this can comprise, among other things, snapping the first and second connector elements together, connecting pieces of hook-and-loop material together, or attaching magnets together. Alternatively, in the exemplary embodiments of FIGS. 5-9, this can comprise placing the ornament 120 over the retainer member 112 in the first angular orientation and inserting the second connector element 115 into the aperture 114 in the retainer member 112. Then, the ornament 120 can be rotated to the second angular orientation, for example, by approximately 90 degrees, thereby causing the ornament 120 and the retainer member 112 to twist-lock together.

In the instance where the animal's caretaker wishes to change the ornament to a new one, the ornament 20, 120 can be disconnected from the retainer member 12, 112 and replaced with a new one. In the exemplary embodiments of FIGS. 1-4, this can comprise unsnapping the snaps, separating the pieces of hook-and-loop material, or disconnecting the magnets. In the exemplary embodiments of FIGS. 5-9, this can comprise rotating the ornament 120 from the second angular orientation to the first angular orientation, and pulling the second connector element 115 from the aperture 114. Upon separation of the ornament 20, 120 from the retainer member 12, 112, the ornament can be replaced with a new and/or different one, as described previously.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. An ornamental accessory, comprising:
a retainer member adapted to fit at least partially around a length of material, the retainer member including a first connector element; and
an ornament including a second connector element adapted to removably connect with the first connector element.

2. The accessory of claim 1, wherein the length of material comprises an animal collar.

3. The accessory of claim 1, wherein the retainer member includes opposed first and second longitudinal ends separated by an opening.

4. The accessory of claim 1, wherein the first connector element comprises an aperture in the retainer member, and the second connector element comprises a projection on the ornament, the aperture adapted to receive the projection.

5. The accessory of claim 4, wherein the projection is sized and dimensioned to pass through the aperture when the ornament is located in a first angular orientation with respect to the retainer member, and the projection is sized and configured to prevent passage of the projection through the aperture when the ornament is located in a second angular orientation with respect to the retainer member.

6. The accessory of claim 5, wherein the second connector element further comprises a stem extending between the projection and the ornament.

7. The accessory of claim 5, wherein the first angular orientation and the second orientation are offset by approximately 90 degrees from one another.

8. The accessory of claim 5, further comprising a blocking member adapted to engage a portion of the retainer member when the ornament is located in the second angular orientation with respect to the retainer member, thereby inhibiting rotation of the ornament to the first angular orientation.

9. The accessory of claim 8, wherein the blocking member comprises a ramp member located on the ornament.

10. The accessory of claim 1, wherein the first connector element and the second connector element comprise cooperating pieces of hook-and-loop fastener.

11. The accessory of claim 1, wherein the first connector element and the second connector element snap together.

12. The accessory of claim 1, wherein the first connector element and the second connector element comprise magnetic elements.

13. The accessory of claim 3, further comprising a clasp extending across the opening, the clasp having a first portion attached to the first longitudinal end, and a second portion attached to the second longitudinal end.

14. The accessory of claim 1, wherein the retainer member is leather.

15. The accessory of claim 1, wherein the retainer member is plastic.

16. The accessory of claim 1, further comprising at least a second ornament having a second connector element adapted to removably connect with the first connector element.

17. The accessory of claim 16, wherein the second ornament is different than the first ornament.

18. The accessory of claim 1, wherein the ornament includes identifying information about an animal wearing the ornamental accessory.

19. A method of attaching an ornamental accessory to a length of material, comprising:
placing a retainer member at least partially around a portion of the length of material; and
connecting a first connector element located on the retainer member with a second connector element located on the ornament.

20. The method of claim 19, wherein the length of material comprises an animal collar.

21. The method of claim 19, wherein the retainer member includes opposed first and second longitudinal ends separated by an opening

22. The method of claim 19, wherein connecting the first connector element with the second connector element comprises:
holding the ornament in a first angular orientation with respect to the retainer member;
inserting the first connector element into the second connector element; and
rotating the ornament with respect to the retainer member from the first angular orientation to a second angular orientation.

23. The method of claim 22, further comprising:
removing the ornament from the retainer; and
replacing the ornament with a second ornament that is different from the first ornament.

24. The method of claim 23, wherein removing the ornament from the retainer comprises:
rotating the ornament from the second angular orientation to the first angular orientation; and
removing the first connector element from the second connector element.
